(19) United States
(12) Patent Application Publication
(10) Pub. No.: US 2013/0301861 A1
(43) Pub. Date: Nov. 14, 2013

(54) EXTENDABLE SOUND BAR

(71) Applicants: Wei-Teh Ho, Taipei (TW); Wei-Yu Ho, Taipei (TW)

(72) Inventors: Wei-Teh Ho, Taipei (TW); Wei-Yu Ho, Taipei (TW)

(21) Appl. No.: 13/467,900

(22) Filed: May 9, 2012

(51) Int. Cl. H04R 1/02

(52) U.S. Cl. 381/332

(57) ABSTRACT

An extendable sound bar assembly comprising at least an extending bar segment and a plurality of detachable bar segments is described, the extending bar segment having first and second locking structures, the detachable bar segments including first and second bar segments. The first bar segment can include a third locking structure capable of interlocking with the first locking structure to allow the first bar segment to be attached to and detached from the extending bar segment. The second bar segment can include a fourth locking structure capable of interlocking with the second locking structure to allow the second bar segment to be attached to and detached from the extending bar segment. The first and second bar segments can be aligned with the extending bar segment to form a single sound bar.

### FIELD OF INVENTION

The present invention relates generally to a sound bar. More particularly, this invention relates to an extendable sound bar having a replaceable segment to provide a speaker system adaptable for different sizes of media player devices.

### BACKGROUND

Sound systems, such as surround sound systems, are usually employed to provide improved sound effects for media playing devices, such as televisions, DVD (Digital Versatile/Video Disc) players, CD (Compact Disc) players, MP3 (Moving Picture Experts Group Audio Layer III) players, etc. However, with the advancement of technologies, dimensions of media player devices are constantly changing. For example, bigger, cheaper, and thinner display devices have become a common trend for new generations of media display devices.

Sound system assembly based on fixed sized components may be short-lived and become obsolete as the market adopts new media player devices with incompatible sizes. Consequently, manufactures may be forced to produce new sound systems updated with different dimensions to meet the need of the market. With the accelerated speed of changes in media player devices, both the suppliers and consumers of sound systems may be burdened to pay significant cost just to catch up with the evolution of device dimensions.

Therefore, updates of dimensions for traditional sound system assembly may be wasteful, costly and not competitive.

### SUMMARY OF THE DESCRIPTION

A extendable sound bar device is disclosed. In one embodiment, the sound bar device comprises a middle bar segment attached with a left bar segment at one end and a right bar segment at the other end. The right bar segment and the left bar segment are disposed with speakers of a surround sound system. The middle bar segment can be detached and replaced with a separate bar segment to extend and adapt the sound bar device to reuse left and right bar segments and the housed speakers for different sizes of media playing devices. For example, a sound bar device used for a 42 inch TV may be adapted for another 60 inch TV by simply replacing an existing middle bar segment with a separate middle bar segment 18 inches longer than the existing middle bar segment while reusing both left and right bar segments of the sound bar device.

In one embodiment, an extendable sound bar assembly can comprise at least an extending bar segment and a plurality of detachable bar segments (or sections). The extending bar segment can have a first end and a second end. The first end can have a first locking structure. The second end can have a second locking structure. The detachable bar segments can include a first bar segment and a second bar segment, each having one or more speakers disposed therein. The first bar segment can include a third locking structure capable of interlocking with the first locking structure of the extending bar segment to allow the first bar segment be attached to and detached from the extending bar segment. The second bar segment can include a fourth locking structure capable of interlocking with the second locking structure of the extending bar segment to allow the second bar segment to be attached to and detached from the extending bar segment. In one embodiment, when the first and second bar segments are interlocked with and attached to the extending bar segment, the first and second bar segments are aligned (e.g. commonly shaped in cross-section) longitudinally with the extending bar segment to form a single sound bar.

In another embodiment, an extendable sound bar assembly can comprise a plurality of detachable bar segments forming a single sound bar. Each of the bar segments may be fittingly attached to an adjacent one of the bar segments. Each bar segment can have a joint structure at one end attached to an adjacent bar segment along the extendable sound bar. The adjacent bar segment can have a matching joint structure at one end in contact with (or attached to) the bar segment. The joint structure and the matching joint structure may be engaged to join, attach or lock together the bar segment and the adjacent bar segment. In one embodiment, the bar segments can include one or more speaker segments and zero or more extending segments. Each speaker segment can house one or more speakers mounted therein. The length of the sound bar along its longitudinal direction may correspond to sum of lengths of each individual bar segment to allow varying a dimension of the sound bar by replacing the extending segment without requiring changes in the speakers.

Other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

The present invention is illustrated by way of examples and not limitations in the figures of the accompanying drawings, in which like references indicate similar elements and in which:

FIG. 1 is a perspective view of an embodiment of an extendable sound bar with a replaceable segment;

FIG. 2 is a multi-view of an embodiment of an extendable sound bar with a replaceable segment;

FIG. 3 is an exploded multi-view of an embodiment of an extendable sound bar with a replaceable segment;

FIG. 4 is an exploded multi-view of an embodiment of an extendable sound bar without a replaceable segment;

FIG. 5 is a schematic diagram illustrating an embodiment of an extendable sound bar providing a surround sound system for a media player;

FIG. 6 is a schematic diagram illustrating an alternative embodiment of an extendable sound bar providing a surround sound system for a media player;

FIG. 7 is a schematic diagram illustrating an embodiment of an extendable sound bar integrated with a multi-media player device;

FIG. 8 is a schematic diagram illustrating an alternative embodiment of an extendable sound bar integrated with a multi-media player device;

### DETAILED DESCRIPTION

In the following description, numerous specific details are set forth, such as examples of external surfaces, named components, connections between components, etc., in order to provide a thorough understanding of the present invention. It will be apparent, however, to one skilled in the art that the present invention may be practiced without these specific details. In other instances, well known components or methods have not been described in detail but rather in a block diagram in order to avoid unnecessarily obscuring the present invention. Further specific numeric references such as first, second, third, etc., may be made. However, the specific numeric references should not be interpreted as a literal sequential order but rather interpreted as references to different objects. Thus, the specific details set forth are merely exemplary. The specific details may be varied from and still be contemplated to be within the spirit and scope of the present invention.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

In one embodiment, a sound bar housing speakers may include detachable and replaceable bar segments separate from the speakers. Unlimited number of sizes (or lengths) may be configured for the sound bar by selecting a proper sized or configured extending bar segment while reusing the speakers for adapting the sound bar (e.g. dimensionally) to different and evolving sizes of target media player devices. As a result, the manufacturing process to adjust the size of the sound bar device (e.g. complexities of molds for making the sound bar) may be significantly simplified while providing versatilities to leverage various sizes of the extending bar segment which does not house speakers.

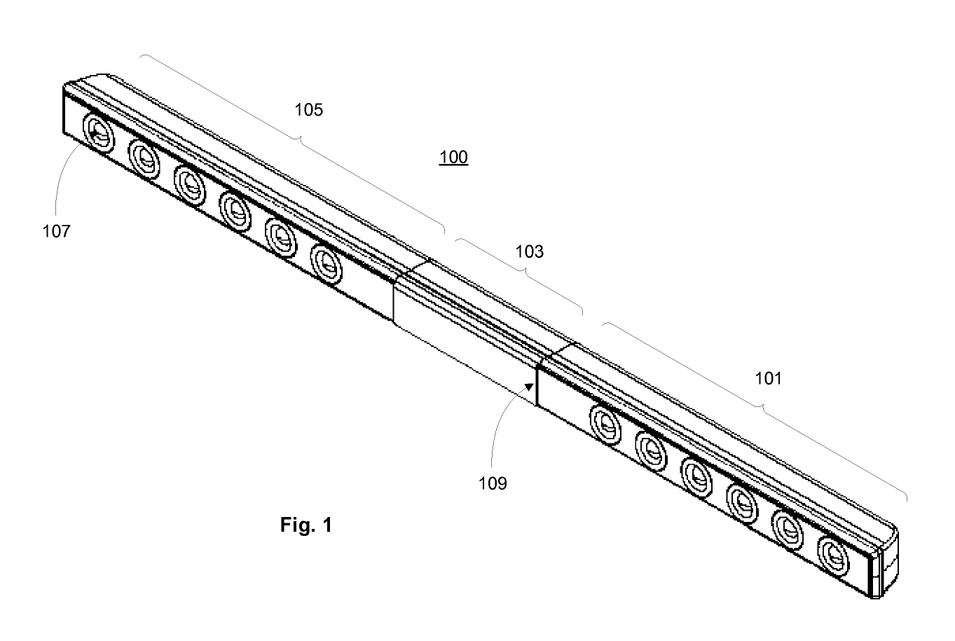

FIG. 1 is a perspective view of an embodiment of an extendable sound bar with a replaceable segment. Sound bar 100 can comprise a left segment (or section) bar 105, a middle extending bar segment 103 and a right bar segment 101. Sound bar 100 may be assembled by concatenating one bar segment attached (e.g. at a joint) with another bar segment along a longitudinal direction of the sound bar. For example, bar segment 101 may be attached with bar segment 103 at joint 109. At a joint, cross sections of adjacent bar segments, such as bar segments 101, 103, can match each other to allow close fitting to hide the joint from appearance of an assembled sound bar.

A bar segment can be detachable (or disassembled) from a sound bar, for example, to allow the sound bar to be reconfigured (or reassembled) with a replacement bar segment replacing the detached bar segment. For example, sound bar 100 may be of a length corresponding to sum of lengths of bar segments 101, 103 and 105. Sound bar 100 may be extended or shrunk in length by replacing bar segment 103 with a replacement bar segment longer or shorter than bar segment 103.

In one embodiment, left bar segments 105 and right bar segment 101 can house (or be disposed or mounted with) multiple speakers, such as speaker 107. Speakers in one bar segment, such as bar segment 101 or bar segment 105, may support one of multiple channels of stereo sound. Extending bar 103 may be functionally coupled with speakers of bar segments 101, 105. For example, extending bar 103 may include control elements for adjusting sound produced by the speakers. Alternatively or optionally, extending bar 103 may be attached for adjusting dimension of sound bar 100, for example, to be compatible with the size of a media player device coupled with the speakers of sound bar 100.

A sound bar may include multiple speaker bars and extending bars interleaved or arranged in a configurable manner. Cross-sectional shape of the sound bar may be rectangular, spherical, ellipse, triangular or other applicable shape. Thus, the sound bar may be a thin elongated panel, a round bar, a rectangular bar, or a bar of other applicable shape with adjustable lengths or sizes.

In one embodiment, an extendable sound bar can include one or more (e.g. two) speaker segments (or speaker bar segments) adjacent to each other without including extending segments (or extending bar segments) to reduce or minimize the dimension (e.g. minimum length) of the extendable sound bar. Adjacent speaker segments can be attached, for example, via a joint formed by a joint structure and a matching joint of the adjacent speaker segments respectively.

Alternatively, the extendable sound bar can be formed by inserting one or more extending segments to increase the length (e.g. longer than the minimum length). As a result, each speaker segment may be attached to at least one of the extending segments inserted. For example, different sizes of extending segments can be placed or attached between two speaker segments to increase the overall length of the sound bar to match the width of a separate media device, such as TV which may be coupled with the sound bar (or speakers of the sound bar).

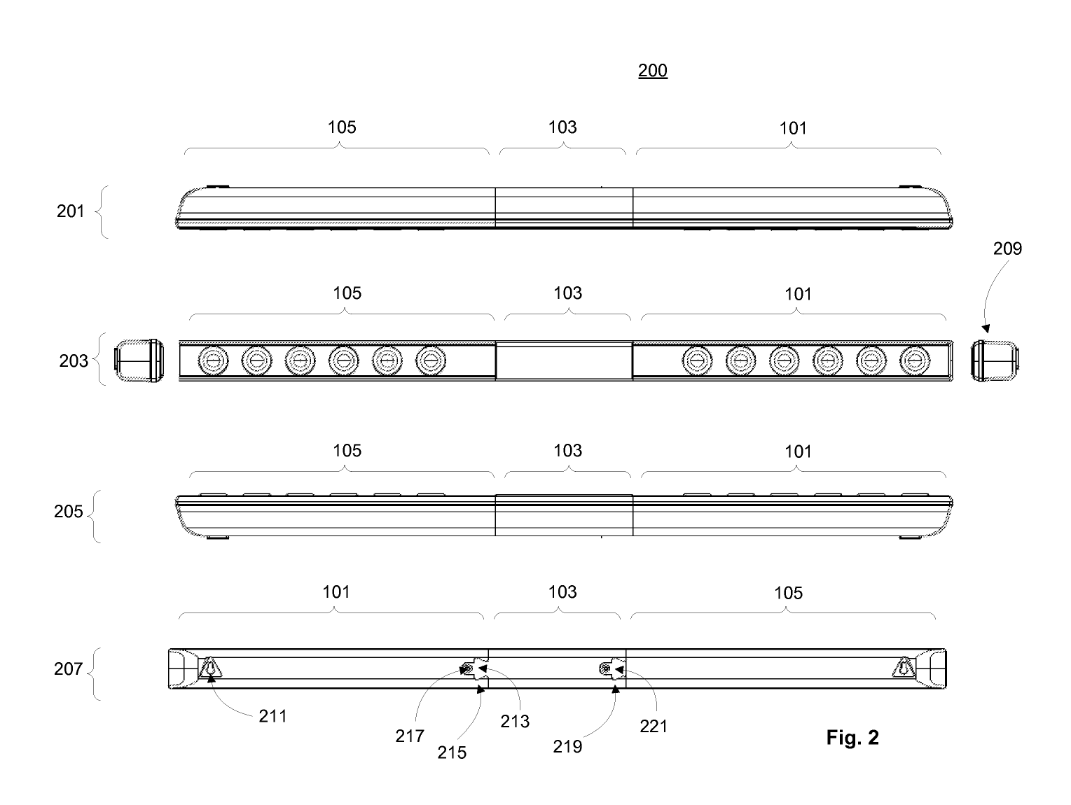

FIG. 2 is a multi-view of an embodiment of an extendable sound bar with a replaceable segment. View 200 may include top view 201, front view 203, bottom view 205 and back view 207 of sound bar 100 of FIG. 1. Extending bar segment 103 may be replaceable such that the dimension (e.g. length) of sound bar 100 can be modified without requiring changes in the speakers or speaker bar segments 101, 105. Two ends of the sound bar may be covered with caps, such as cap 209, for aesthetic purposes.

Each bar segment can have a joint structure at one end or both ends of the bar segment to secure a joint with an adjacent bar segment. For example, bar segment 101 may have a female joint (or tail) 215 matching a male joint (or pin) of adjacent bar segment 103. Matching joint structures can be of substantially the same three dimensional shapes to seamlessly form a joint.

In one embodiment, a joint between adjacent bar segments may be configured or shaped as a dovetail joint to secure or align the adjacent bar segments along the longitudinal direction of a sound bar. A locking structure or a joint of the sound bar can be formed by engaging matching joint structures, such as a male joint and a female joint, between adjacent bar segments in a direction substantially perpendicular to a longitudinal direction of the sound bar. Additionally or optionally, a joint may include mechanical fasteners, such as screw 217, to further secure or fasten the adjacent segment perpendicular to the longitudinal direction of the sound bar. Hanging slot 211 on the back side of the sound bar may allow the sound bar to be mounted on a vertical surface, such as a wall.

In some embodiments, bar segment 103 can be an extending bar segment having a first end adjacent to bar segment 101 and a second end adjacent to bar segment 105. The first end can have a locking structure 213 with a protruding joint tong (or male joint). The second end can have locking structure 219 with a recessive joint slot (or female joint). Multiple detachable bar segments, such as bar segments, 101, 105, disposed with speakers can be attached with the extending bar segment 103. Bar segment 101 can include locking structure 215 capable of interlocking with locking structure 213 to allow bar segment 101 be attached to and detached from the extending bar segment.

Similarly, bar segment 105 can have a locking structure 221 (e.g. male joint) capable of interlocking with locking structure 219 (e.g. female joint) of the extending bar segment 103 to allow bar segment 105 to be attached to and detached from the extending bar segment 103. In one embodiment, bar segments 101, 105 are interlocked with and attached to the extending bar segment 103 to align and secure bar segments 101, 103, 105 to form a single sound bar.

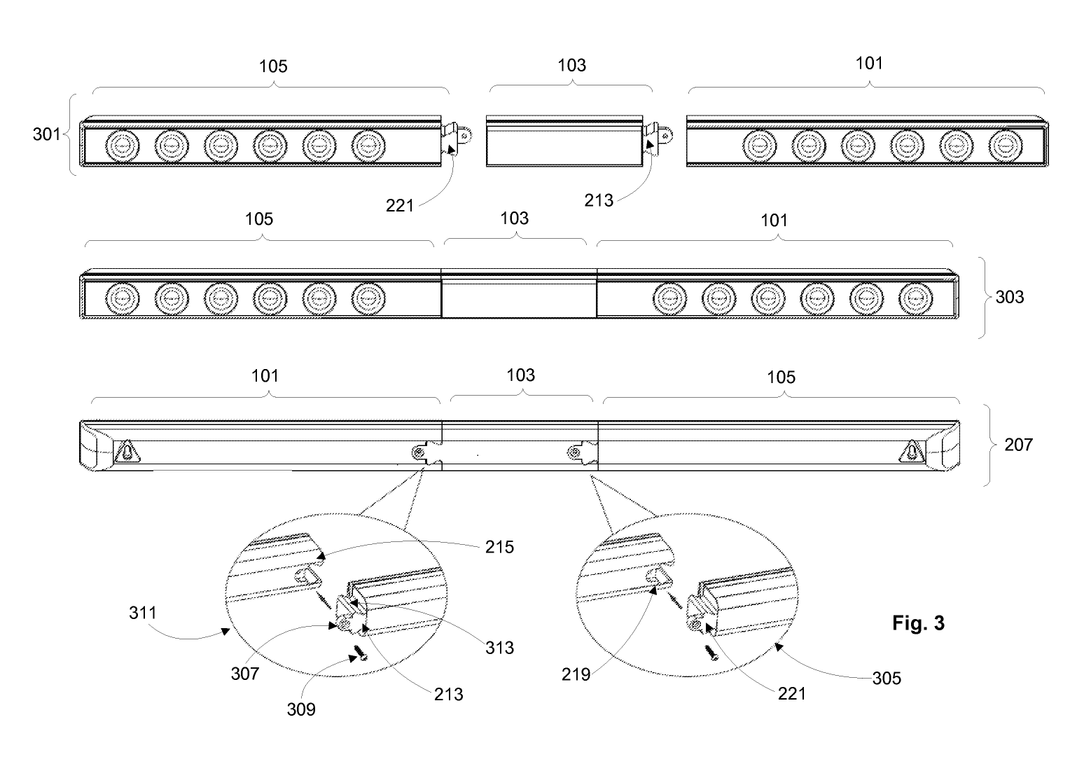

FIG. 3 is an exploded multi-view of an embodiment of an extendable sound bar with a replaceable segment. Front view 301 may represent disassembled (or unassembled) bar segments 105, 103, 101 of the sound bar. Front view 303 may represent an assembly of bar segments 105, 103, 101 for the sound bar. In one embodiment, bar segment 103 may be replaced with a separate bar segment of a different size, performing an additional function and/or having a different aesthetic appearance etc., from bar segment 103. The replaced separate bar segment can include joint structures similar to those of bar segment 103 to be attached with bar segments 101, 105 for the sound bar.

Exploded schematics 311, 305 may illustrate joint structures to form joints connecting bar segment 103 together with bar segments 101, 105. For example, female joint 215 of bar segment 101 may be coupled with male joint 213 of bar segment 103 in a direction substantially perpendicular to a longitudinal direction of the sound bar (or other applicable direction to fix adjacent bar segments 101, 103 aligned along the longitudinal direction of the sound bar).

Joint structures 213, 215 may be configured with threaded surface 313 to provide additional strength to firmly attach the adjacent bar segments. The tip of a male joint (or tong) may include a nut 307 to allow a screw 309 to fasten the joint in an assembled position. Schematic 305 illustrates similar attachment between bar segments 103, 105 via male join 221 of bar segment 105 and a matching female join 219 of bar segment 103.

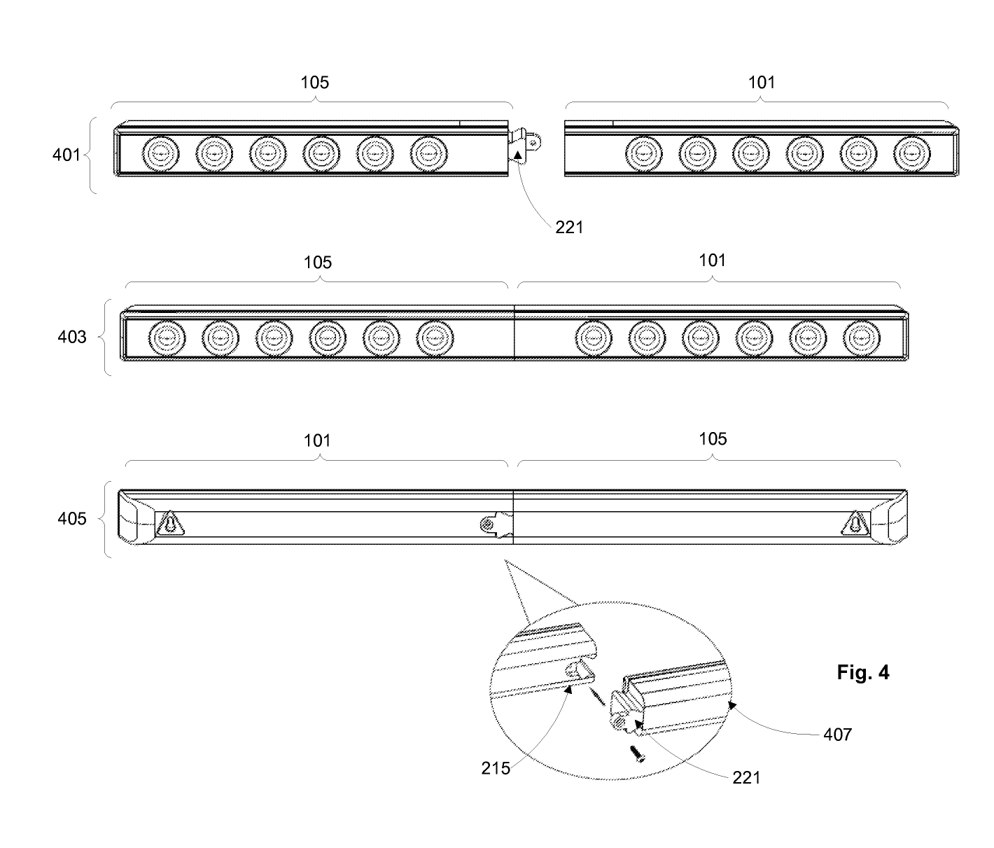

FIG. 4 is an exploded multi-view of an embodiment of an extendable sound bar without a replaceable segment. For example, an extendable sound bar formed by speaker bar segments 101, 105 may represent a shortest sound bar assembly without a replaceable segment. An extending bar segment, such as segment 103 of FIG. 1, may be a replacement segment. View 401 can represent a front view illustrating a disassembled (or detached) sound bar including two speaker bar segments 101, 105 attachable with each other directly. Front view 403 may represent an assembly of bar segments 101,105 for the sound bar. Exploded schematic 407 illustrates a joint formed via female joint 215 of bar segment 101 and matching male joint 221 of bar segment 105.

Alternatively, a joint may be formed via a male joint (e.g. similar to male joint 221) of bar segment 101 and a matching female joint (e.g. similar to female joint 215) of bar segment 105. Male joint 221 may be similarly constructed (or molded) as male joint 213 of segment 103 in FIG. 3. Female joint 215 may be similarly constructed as female joint 219 of segment 103. Thus, either one of male joints 221, 213 can form a locking structure (or joint) with either one of matching female joints 215, 219. As a result, a sound bar can be assembled by attaching segments 101, 103, 105 or segments 101, 105 (without segment 103) based on different matching pairs of male and female joints already built-in in each segment.

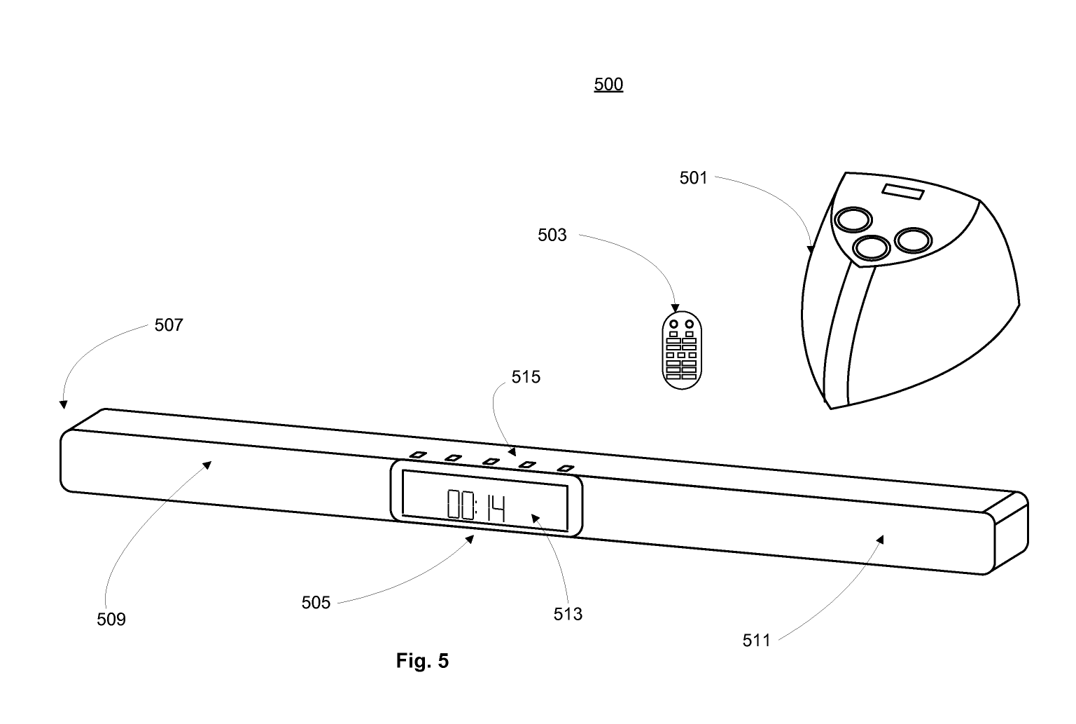

FIG. 5 is a schematic diagram illustrating an embodiment of an extendable sound bar providing a surround sound system for a media player. For example, extendable sound bar 507 can include speaker bars 509, 511 (e.g. corresponding to speaker bar segments 105, 101 of FIG. 1). Surround sound system 500 can include a subwoofer 501 wirelessly coupled with speakers disposed in speaker bars 509, 511 to provide audio output for system 500. Subwoofer 501 may be a woofer, or a complete loudspeaker, which is dedicated to the reproduction of low-pitched audio frequencies (e.g. bass) for system 500.

Sound bar 507 may include an extending or replaceable bar segment 505 housing a media player device, such as a CD player, MP3 player, or other applicable media player with a display 513 providing visual information on media playing and/or control switches (e.g. channels, volumes, power on/off etc.) 515 of the media player device. In one embodiment, bar segment 505 may include a mass storage device, such as flash memory device, USB (universal serial bus) device, hard drive device, etc., for example, to provide storage for media data or other data. Optionally or additionally, functions or operations of sound bar 507 may be controlled via remote control device 503. The media player device may be hidden or merged within with the extending bar segment 505. Sound bar 507 may be a single rectangular bar embedding a media player device.

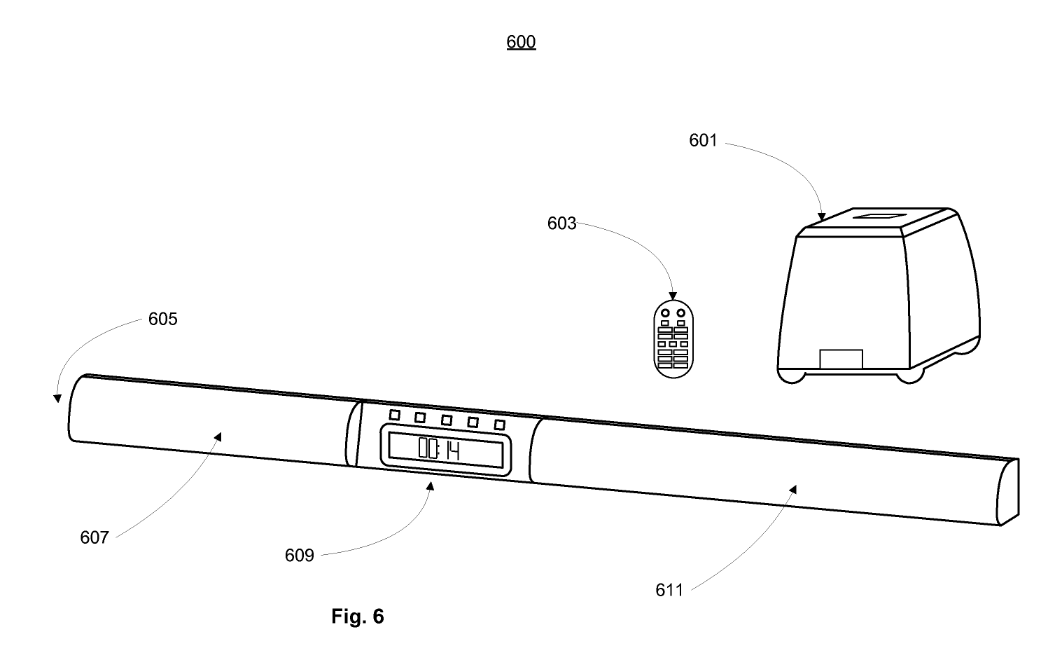

FIG. 6 is a schematic diagram illustrating an alternative embodiment of an extendable sound bar providing a surround sound system for a media player. System 600 can include a surround sound system including sound bar 605 embedding a media player. Sound bar 605 may include an extending bar 609 with display and controls for the media player and bar segments 607, 611 housing speakers to provide audio output for system 600. In some embodiments, extending bar 609 may include control elements for a surround sound system based on sound bar 605. Optionally or additionally, system 600 can include subwoofer 601 and/or remote control 603 wirelessly coupled with sound bar 605. Sound bar 605 may be a single non-rectangular bar (e.g. with a curved front surface) hiding a media player device within extendable bar segment 609.

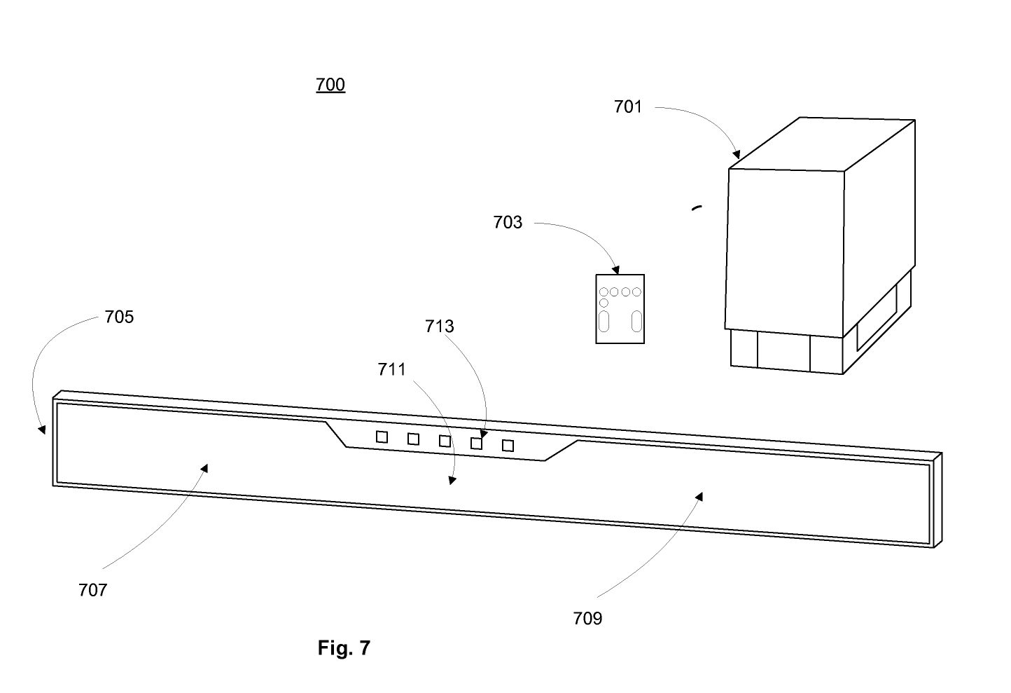

FIG. 7 is a schematic diagram illustrating an embodiment of an extendable sound bar integrated with a multi-media player device. For example, extendable sound bar 705 can include speaker bars 707, 709 housing speakers of a surround sound system 700 for a media player device, such as a DVD player device. Sound bar 705 can also include extending bar 711 attached with speaker bars 707, 709 with the media player device embedded within. Extending bar 711 may include status control elements (or display) 713 for media player device, such as channel up/down, volume up/down, power on/off etc. Optionally or additionally, system 700 can include subwoofer 701 and/or remote control 703 wirelessly coupled with sound bar 705.

System 700 may be coupled with a separate display device, such as a flat panel display or an applicable TV device to provide video output for the media player device of sound bar 705. Alternatively, extending bar segment 711 may include a control device for a separate media player device coupled with sound bar 705. Extending bar segment 711 may be configured with a size (or length) to ensure compatibility (e.g. substantially the same or aesthetically similar according to certain predetermined ratio or size differences) between the length of sound bar 705 and the width of the flat panel display device. In one embodiment, sound bar 705 may appear as a single thin or flat rectangular bar with a smooth surface (e.g. without distinctions or indistinguishable) between speaker bars 707, 709 and extending bar 711.

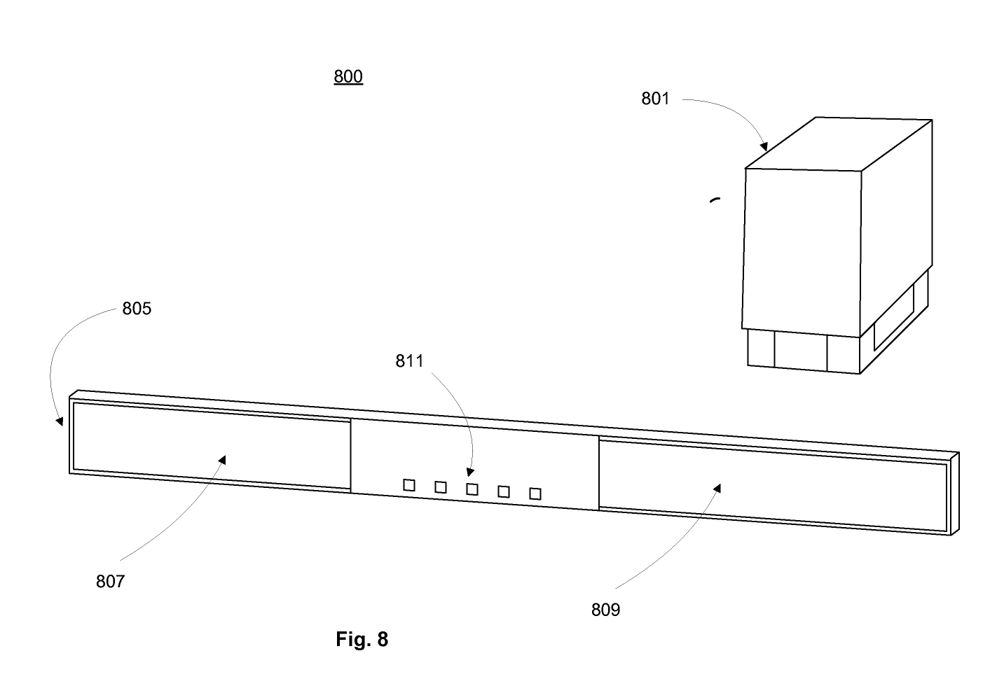

FIG. 8 is a schematic diagram illustrating an alternative embodiment of an extendable sound bar integrated with a multi-media player device. For example, extendable sound bar 805 can include speaker bars 807, 809 housing speakers of a surround sound system 800 to provide audio output for a media player device, such as a separate flat panel TV with a size (e.g. width) compatible with the length of sound bar 805. Sound bar 805 can also include extending bar 811 attached with speaker bars 807, 809 with a display or control for the audio, such as volume control, power control, channel selection, stereo effects, woofer effects, etc. System 800 may include subwoofer 801 remotely coupled with sound bar 805.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An extendable sound bar assembly comprising:
an extending bar segment having a first end and a second end, the first end having a first locking structure, the second end having a second locking structure; and
a plurality of detachable bar segments including a first bar segment and a second bar segment, each having one or more speakers disposed therein, wherein the first bar segment includes a third locking structure capable of interlocking with the first locking structure of the extending bar segment to allow the first bar segment to be attached to and detached from the extending bar segment, wherein the second bar segment includes a fourth locking structure capable of interlocking with the second locking structure of the extending bar segment to allow the second bar segment to be attached to and detached from the extending bar segment, wherein when the first and second bar segments are interlocked with and attached to the extending bar segment, the first and second bar segments are aligned with the extending bar segment to form a single sound bar.

2. The assembly of claim 1, wherein the first locking structure and the second locking structure, when interlocked with each other, form a joint between the extending bar segment and the first bar segment.

3. The assembly of claim 2, wherein the joint is formed by engaging the first locking structure with the second locking structure in a direction perpendicular to a longitudinal direction of the sound bar.

4. The assembly of claim 2, wherein the first locking structure and the second locking structure comprise a joint slot and a joint tong similarly shaped to allow the joint tong to be positioned closely fittingly within the joint slot.

5. The assembly of claim 4, wherein the joint tong includes a screw nut at tip of the tong and wherein the joint slot and the joint tong are fastened via a screw in the screw nut.

6. The assembly of claim 1, wherein the speakers of the speaker bars belong to a surround sound system optionally coupled to a media player device to provide audio output for the media player device, the media player device sized with a dimension compatible with the sound bar.

7. The assembly of claim 6, wherein the surround sound system includes a subwoofer device wirelessly coupled with the speakers.

8. The assembly of claim 6, wherein the extending bar comprises the media player device.

9. The assembly of claim 6, wherein the extending bar comprises a mass storage device, and wherein the mass storage device storing media to be played via the media player device.

10. The assembly of claim 1, wherein each of the first and second bar segments has at least one hanging slot to secure the sound bar on a vertical surface.

11. An extendable sound bar assembly comprising:
a plurality of detachable bar segments, each bar segment fittingly attached to an adjacent one of the bar segments, the bar segment having a joint structure at one end attached to the adjacent bar segment, the adjacent bar segment having a matching joint structure at one end attached to the bar segment, the joint structure and the matching joint structure engaged to attach the adjacent bar segments, wherein the bar segments include one or more speaker segments and zero or more extending segments, each speaker segment housing one or more speakers mounted within the speaker segment, wherein the detachable bar segments form a single sound bar, wherein length of the sound bar corresponds to sum of lengths of the bar segments to allow varying a dimension of the sound bar by replacing the extending segments without changes in the speakers.

12. The assembly of claim 11, wherein the one or more speaker segments include no more than two speaker segments having respectively the joint structure and the matching joint structure, wherein the no more than two speaker segments are attached with each other directly via the joint structure and the matching joint structure, and wherein the sound bar is formed without extending segments with the length corresponding to a minimum length the sound bar.

13. The assembly of claim 11, wherein sum of lengths of the one or more speaker segments corresponds to a minimum length for the sound bar, wherein the sound bar is formed with one or more of the extending segments to increase the length to be longer than the minimum length, and wherein each speaker segment is attached to at least one of the extending segments.
